(19) United States
(12) Patent Application Publication
(10) Pub. No.: US 2023/0183400 A1
(43) Pub. Date: Jun. 15, 2023

(54) SYSTEM AND METHOD FOR CATALYST PREPARATION

(71) Applicant: Chevron Phillips Chemical Company LP, The Woodlands, TX (US)

(72) Inventors: William C. Ellis, Bartlesville, OK (US); Max P. McDaniel, Bartlesville, OK (US); Deloris R. Gagan, Ramona, OK (US)

(21) Appl. No.: 18/165,969

(22) Filed: Feb. 8, 2023

Related U.S. Application Data
(62) Division of application No. 16/671,573, filed on Nov. 1, 2019.

(51) Int. Cl. C08F 210/02

(52) U.S. Cl. CPC C08F 210/02

(57) ABSTRACT

Techniques are provided for catalyst preparation. A method includes heating a mixture of one or more transition metal compounds and an oxide support or a chromium containing oxide support to a temperature or a set of temperatures that enables the a transition metal compound of the one or more transition metal compounds to sublime, melt, or thermally decompose, such that a transition metal of the one or more transition metal compounds reacts with and is deposited onto a surface of the oxide support or the chromium containing oxide support to form a catalyst, and activating the catalyst. The catalyst is configured to facilitate a reaction that produces a target inorganic material.

### BACKGROUND

This section is intended to introduce the reader to aspects of art that may be related to aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Catalysts can be employed to facilitate the formation of products through chemical reactions. The catalyst may be prepared in a certain way to achieve desired properties of the catalyst and/or the products. In some cases, a transition metal compound may react with a support material and/or otherwise form a coating on the support material to form the catalyst. Typically, a solvent is utilized to enable the transition metal compound to react with the support material and the solvent is later removed to generate the catalyst product. Unfortunately, using the solvent may increase the costs of producing the catalyst and/or increase the production time for generating the catalyst.

### BRIEF DESCRIPTION OF THE DRAWINGS

Advantages of the present disclosure may become apparent upon reading the following detailed description and upon reference to the drawings in which:

FIG. 1 is a schematic of an embodiment of a system for forming a catalyst, in accordance with present embodiments;

FIG. 2 is a schematic of an embodiment of a system for forming a catalyst using a masterbatch process, in accordance with present embodiments;

FIG. 3 is a flow chart of an embodiment of a solventless metal loading process for forming the catalyst, in accordance with present embodiments;

FIG. 4 is a flow chart of an embodiment of the solventless metal loading process for forming the catalyst, in accordance with present embodiments;

FIG. 5 is a flow chart of an embodiment of the solventless metal loading process for forming the catalyst, in accordance with present embodiments; and

FIG. 6 is a flow chart of an embodiment of the masterbatch process for forming the catalyst, in accordance with present embodiments.

### DETAILED DESCRIPTION OF SPECIFIC EMBODIMENTS

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The terminology used herein is for describing particular embodiments only and is not intended to be limiting of example embodiments. As used herein, the singular forms “a”, “an” and “the” are intended to include the plural forms as well, unless the context clearly indicates otherwise. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Although the terms first, second, primary, secondary, etc. may be used herein to describe various elements, these elements should not be limited by these terms. These terms are only used to distinguish one element from another. For example, but not limiting to, a first element could be termed a second element, and, similarly, a second element could be termed a first element, without departing from the scope of example embodiments. As used herein, the term “and/or” includes any, and all, combinations of one or more of the associated listed items.

The present disclosure is directed to techniques for catalyst preparation and generating catalyst compositions. More specifically, the present disclosure is directed to techniques for catalyst preparation using solventless metal loading. As used herein, the term “solventless metal loading” refers to a technique for adhering one or more transition metal compounds to an oxide support material without the use of a liquid solvent to enable the transition metal compound to be disposed onto the oxide support material. In some embodiments, solventless metal loading may utilize sublimation to vaporize the transition metal compound from a solid phase. The transition metal compound in a vapor phase may then react with and/or otherwise bond to a surface of the oxide support material in order to generate the catalyst. Additionally or alternatively, the solventless metal loading may include thermal decomposition of the transition metal compound that enables the transition metal compound to bond to the surface of the oxide support material. In some embodiments, the solventless metal loading process may include one or more thermal treatment procedures (e.g., temperature programs and/or atmospheric controls) performed on the oxide support material and/or the transition metal compound. The thermal treatment procedures include increasing a temperature of a reactor vessel that includes the oxide support material and/or the transition metal compound and/or maintaining a temperature of the reactor vessel. In some embodiments, the solventless metal loading process may include solventless titanation, which may utilize a solid phase compound having titanium as the transition metal compound. Formation of the catalyst using the solventless metal loading process may enable the catalyst to include properties that facilitate a reaction that generates organic and/or inorganic materials, such as polymers, having enhanced properties. As used herein, the “catalyst” may refer to a catalyst product that is used to facilitate a reaction (e.g., a polymerization reaction) to generate an organic and/or an inorganic material (e.g., a polymer, such as polyethylene and/or high density polyethylene) and/or a catalyst precursor that may undergo activation and/or further treatment before being used in the reaction. The catalyst may include a Phillips catalyst that includes chromium, silicon oxide (SiO₂), titanium (Cr/SiO₂/Ti), and/or chloride (Cr/SiO₂/Ti/Cl).

Existing catalyst preparation techniques utilize metal loading to adhere the transition metal compound to the surface of the oxide support material. Metal loading may generate a catalyst having a uniform coating of the transition metal compound that enables the catalyst to initiate or otherwise cause a reaction. For instance, catalysts may be used in a polymerization reaction to facilitate formation of polymers. Catalysts prepared using metal loading may increase a reaction activity of the polymerization reaction (e.g., achieve a greater amount of polymer per unit catalyst), thereby reducing operating expenses for a polymer manufacturing plant. In addition, the polymer produced from a polymerization reaction that uses a catalyst prepared with metal loading may have improved properties, such as increased moldability (e.g., molding ease), increased toughness, increased stress crack resistance, and/or improved mechanical characteristics. Existing techniques for metal loading utilize solvents and/or transition metal compounds in a liquid phase in order to enable the transition metal compound to react with the oxide support material. However, removing the solvents from the catalyst may be time consuming, expensive, and/or create additional disposal costs. As such, embodiments of the present disclosure are directed toward a solventless metal loading process for forming the catalyst, which eliminates the use solvents. The solventless metal loading process may ultimately form a catalyst having similar properties and characteristics as existing catalysts, while reducing production costs and production time for producing the catalyst. Further, the solventless metal loading process may be performed in existing catalyst activators.

In some embodiments, the oxide support material may be impregnated with an additional transition metal compound (e.g., a precursor material), such as chromium, prior to the solventless metal loading process. In other embodiments, the additional transition metal compound (e.g., precursor material) may be loaded onto the oxide support material after the solventless metal loading process. In any case, the transition metal compound may undergo sublimation (e.g., transition from a solid phase to a vapor phase) to react with the oxide support material (e.g., oxide support material without the additional transition metal compound) in order to facilitate production of the catalyst and/or the catalyst precursor.

The solventless metal loading process may involve one or more thermal treatment procedures (e.g., temperature programs and/or atmospheric controls) that include heating sequences (e.g., ramps) configured to transition one or more components from a first state (e.g., solid, liquid, or gas) to a second state (e.g., solid, liquid, or gas) and/or to facilitate reactions between components within a reaction vessel. In some embodiments, the solventless metal loading process may include a drying sequence that is configured to remove various components (e.g., water, solvents, and/or other contaminants) from the oxide support material. Additionally or alternatively, the drying sequence may tune a density of a hydroxyl group (e.g., Si—OH) of the oxide support material to facilitate a reaction between the oxide support material and the transition metal compound. In other embodiments, the one or more thermal treatment procedures of the solventless metal loading process may not include the drying sequence.

The one or more thermal treatment procedures may also be performed upon introduction of the transition metal compound into a reactor vessel having the oxide support material (e.g., the oxide support material impregnated with the additional transition metal compound or the oxide support material not having the additional transition metal compound). As such, one or more transition metal compounds (e.g., transition metal compound in the solid phase) and the oxide support material (e.g., oxide support material in the solid phase) may undergo the one or more thermal treatment procedures to ultimately cause sublimation of the transition metal compound, such that the transition metal compound reacts with and/or is otherwise deposited or loaded on the oxide support material. The one or more thermal treatment procedures may include the drying sequence, a metal loading sequence, a holding sequence, and/or an activation sequence (e.g., a calcination sequence occurring in an oxidizing atmosphere, a reducing atmosphere, and/or an inert atmosphere). For example, the metal loading sequence may increase the temperature of the mixture of the transition metal compound and the oxide support material at a target rate to ultimately adjust the temperature of the mixture to the sublimation temperature of the transition metal compound. Accordingly, the transition metal compound may transition directly from a solid phase to a vapor phase during the metal loading sequence. Further, the holding sequence may maintain the temperature of the mixture at or above the sublimation temperature of the transition metal compound to enable substantially all of a transition metal of the solid transition metal compound to vaporize and react with and/or otherwise be coated on the oxide support material. The mixture of the transition metal compound and the oxide support material may then generate the catalyst after the metal loading sequence and/or after the holding sequence. Further still, the activation sequence may include increasing the temperature of the catalyst to a temperature above the sublimation temperature of the transition metal compound to activate (e.g., calcine) the catalyst. It should be understood that the one or more thermal treatment procedures may include one or more of each of the drying sequence, the metal loading sequence, the holding sequence, and/or the activation sequence.

In some embodiments, the solventless loading process may be performed using a masterbatch process. As used herein, the “masterbatch process” refers to a process that includes adding a relatively large amount of raw catalyst or oxide support material (e.g., bulk silica and/or a bulk compound having chromium and silica) to a reactor vessel with a masterbatch composition (e.g., a masterbatch concentrate composition) that includes the catalyst or oxide support material and one or more transition metal compounds. The catalyst or oxide support material and the one or more transition metal compounds may be directed to the reactor vessel at concentrations that enable the catalyst product (e.g., a calcined mixture of the masterbatch composition and the bulk silica) to have a desired final (e.g., target) metal loading.

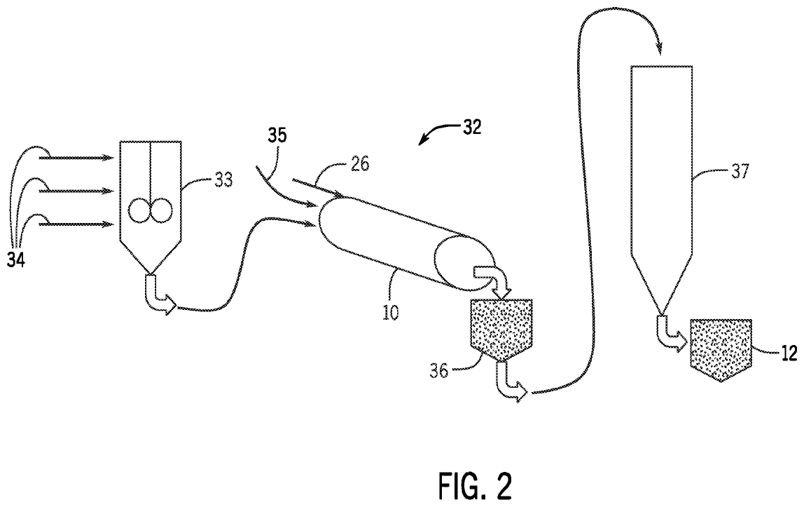

The masterbatch composition may be created by blending the support material (e.g., a silica carrier) with the one or more transition metal compounds (e.g., a titanium compound, such as titanocene dichloride, and/or a chromium compound, such as chromium acetylacetonate) in a solid or liquid phase. Alternatively, the masterbatch composition may also be created by impregnating the support material with a solution of the one or more transition metal compounds, and then evaporating a solvent used to form the solution. Alternatively, some of the solvent may remain in pores of the support material and evaporate in another stage of the masterbatch process, as set forth below with reference to FIG. 2.

The masterbatch composition may be directed through a particle sizing device (e.g., a #40 sieve that includes openings having a diameter of 420 microns) to enable the components of the masterbatch composition to include a substantially uniform particle size.

The masterbatch composition may then be combined with the raw oxide support material (e.g., silica), and the combination may then undergo one or more of the thermal treatment procedures in order to generate pre-catalyst. The amount of the raw oxide support material added per unit of masterbatch composition is defined as a “let-down” ratio. The let-down ratio may determine a final composition of the catalyst product formed as a result of the masterbatch process.

In some embodiments, the batch system may include various supply tanks that include the raw oxide support material and the masterbatch composition. These supply tanks may be coupled to conduits, valves, and/or other features that enable the raw oxide support material and/or the masterbatch composition to be directed toward a reactor vessel (e.g., a fluidized bed, a fixed bed, a quartz tube, a rotary furnace, or another suitable vessel). The reactor vessel may include a heating source that may be controlled via a control system having non-transitory, machine readable media configured to store instructions executable by a processor. The control system may adjust an amount of heat supplied by the heating source to perform the one or more thermal treatment procedures and achieve target temperatures within the reactor vessel that facilitate solventless metal loading of the catalyst.

In some embodiments, the masterbatch composition of the masterbatch process includes a physical mixture of the one or more transition metal compounds, the oxide support material, and/or a chromium containing oxide support material. In other embodiments, the masterbatch composition of the masterbatch process may include the oxide support material previously impregnated with the transition metal compound (e.g., via a solution of the transition metal compound). The masterbatch composition including the impregnated oxide support material may then be dried before undergoing the masterbatch process.

As used herein, the oxide support material may include an oxide, or specifically, an inorganic oxide such as silica, alumina, silica-alumina, titania, silica-titania, alumina-titania, aluminophosphates, magnesia, zirconia, silica-zirconia, alumina-zirconia, ceria, ceria-zirconia, clay, zeolites, or any combination thereof. In some embodiments, the oxide support material may be utilized for generating the catalyst product and/or for other inorganic material applications. The oxide support material may include a surface area and pore volume effective for reacting with and/or otherwise receiving the one or more transition metal compounds. In some embodiments, the surface area of the oxide support material may be between 100 square meters per gram (m²/g) and 1000 m²/g, between 250 m²/g and 1000 m²/g, between 250 m²/g and 700 m²/g, between 250 m²/g and 600 m²/g, or greater than 250 m²/g. Preferably, the surface area of the oxide support material is approximately (e.g., within 10% of, within 5% of, or within 1% of) 500 m²/g. Additionally, the pore volume of the oxide support material may be greater than 0.9 centimeters cubed per gram (cm³/g), greater than 1.0 cm³/g, or greater than 1.5 cm³/g. Preferably, the pore volume of the oxide support material is approximately (e.g., within 10% of, within 5% of, or within 1% of) 1.6 cm³/g. Further, the oxide support material may include an average particle size of between 10 microns and 500 microns, between 25 microns and 300 microns, or between 40 microns and 150 microns. Preferably, the average particle size of the oxide support material may be between 400 and 450 microns. Further still, the oxide support material may include HA30WS, (e.g., a silica-based support material) HA30W (e.g., a silica-based support material having chromium), and/or any suitable silica-based and/or silica-chromium-based support material. The oxide support material may be impregnated with the additional transition metal compound (e.g., a precursor material), such as a chromium containing compound (e.g., chromium (VI) oxide, chromium (III) oxide, chromium acetate, chromium (III) acetylacetonate, chromium (III) nitrate, and/or another suitable chromium containing compound), prior to the solventless metal loading process. In some embodiments, the additional transition metal compound may not include aluminoxane. In other embodiments, raw oxide support material (e.g., oxide support material not impregnated with the additional transition metal compound) may be utilized in the solventless metal loading process and the additional transition metal compound may be loaded onto and/or into the oxide support material before, during, and/or following the solventless metal loading process.

In some embodiments, the one or more transition metal compounds may include a sublimable titanium compound combined with a sublimable chromium compound. For example dicyclopentadienyl titanium dichloride, cyclopentadienyl titanium trichloride, or titanium oxo acetylacetonate, or mixtures thereof, may be combined with chromium acetylacetonate. In this way, the two compounds may react with the oxide support together because the two compounds are intimately associated with one another. Reacting the two compounds together with the oxide support may eliminate separate steps that add each compound during the solventless metal loading process. In another aspect, combining the sublimable titanium compound with the sublimable chromium compound may facilitate generation of a masterbatch composition because the combined sublimable titanium compound and the sublimable chromium compound can be mixed with a larger amount of bulk oxide support material. For example, chromium acetylacetonate can be combined with titanocene dichloride and silica to form a concentrated masterbatch composition. A small amount of this masterbatch composition may be added to a relatively large amount of bulk oxide support material.

In some embodiments, the transition metal compound may include a compound having titanium, and specifically, titanocene dichloride, titanium oxyacetylacetonanate, titanium oxybisacetylacetonate, titanocene dialkoxide, and/or another titanium compound having the formula TiX₄, where “X” represents a halogen (e.g., fluoride, chloride, bromide, iodide, and/or astatide), a leaving group ligand (e.g., monodentate or polydentate), an alkoxide (e.g., methoxide), a dialkoxide (e.g., a glucose derived compound), an acyl (e.g., acetate), and/or a di-acyl (e.g., oxalate). Additionally or alternatively, the transition metal compound may be any transition metal compound that is different from the additional transition metal compound. The transition metal compound may be directed to the reactor vessel in a solid state (e.g., a powder) in order to perform the solventless metal loading process. Accordingly, the transition metal compound may undergo sublimation (e.g., a transition from a solid phase to a vapor phase) in order to react with the oxide support material and form the catalyst product. Sublimation of the transition metal compound may enable a more uniform deposition (e.g., distribution) of the transition metal compound onto the oxide support material, which may enhance the reaction time of a reaction that is facilitated by the catalyst product. Further, solventless metal loading may eliminate the use of solvents, which may reduce costs of manufacturing the catalyst by generally reducing waste production and/or reducing the time for removing the solvent from the catalyst product. In other words, solventless metal loading may eliminate the use of solvents that are included in the reactor vessel for facilitating and/or causing a reaction between the transition metal compound and the oxide support material. In some embodiments, the one or more transition metal compounds or the masterbatch composition are in a solid phase when added to a calcination reactor and/or during the activation sequence (e.g., performed in the reactor or a separate calcination vessel).

In some embodiments, the transition metal compound may include a compound having chlorine (e.g., titanocene dichloride), which may produce hydrochloric acid during the solventless metal loading process. In such embodiments, a scrubber may be incorporated onto and/or into the reactor vessel in order to remove the hydrochloric acid to block the hydrochloric acid from being emitted into a surrounding environment.

In any case, the solventless metal loading process may eliminate the use of solvents in forming a catalyst product for use in a polymerization reaction. Further, solventless metal loading may uniformly coat or load the transition metal compound onto and/or within the oxide support material, which may enhance the polymerization reaction that produces a polymer (e.g., polyethylene). The manufacturing time for generating the catalyst using the solventless metal loading process may be reduced by avoiding the removal of solvents from the catalyst product. For example, polymers produced with catalysts of the present disclosure may have a high load melt index (HLMI) of at least 30 grams/10 minutes (g/10 min).

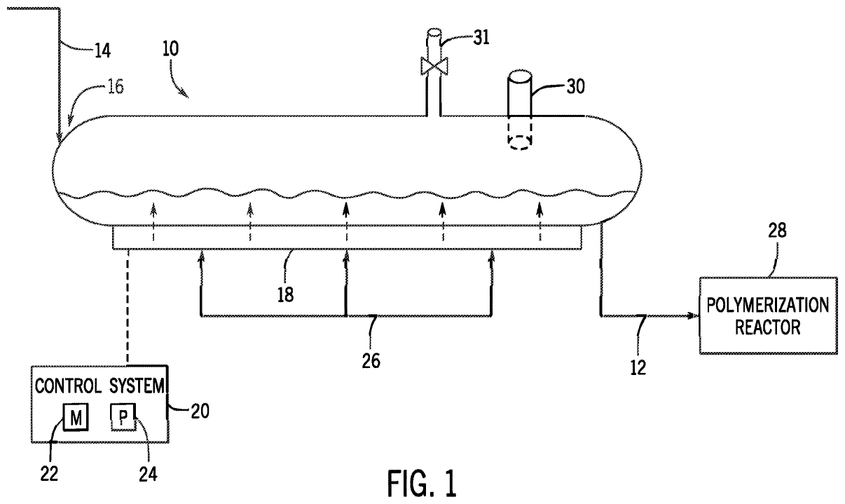

Turning now to the drawings, FIG. 1 is a schematic of an embodiment of a reactor vessel 10 that may be utilized to generate a catalyst product 12 via a solventless metal loading process. In some embodiments, the reactor vessel 10 may be utilized in a continuous process that continuously receives feedstock and outputs product. In other embodiments, the reactor vessel 10 may be utilized in a batch process, where one or more thermal treatment procedures are performed on feedstock in the reactor vessel 10 before outputting a product after the one or more thermal treatment procedures are complete. As shown in the illustrated embodiment of FIG. 1, the reactor vessel 10 may receive one or more feed streams 14 via inlets 16 of the reactor vessel 10. The one or more feed streams 14 may include an oxide support material, one or more transition metal compounds, and/or a masterbatch composition. As set forth above, the oxide support material may include a silica compound, such as HA30WS. The one or more transition metal compounds may include a material having titanium, such as titanocene dichloride. Further, the one or more transition metal compounds may include a compound having chromium, such as chromium acetate and/or chromium (III) acetylacetonate. The one or more feed streams 14 may introduce the oxide support material, the one or more transition metal compounds, and/or the masterbatch composition into the reactor vessel 10 in a solid phase. As such, the one or more transition metal compounds may undergo sublimation as heat is applied to or within the reactor vessel 10, such that the one or more transition metal compounds may react with, or otherwise be deposited or loaded onto a surface of, the oxide support material. The heat applied to the one or more transition metal compounds within the reactor vessel 10 may be at a temperature below a melting point of the transition metal compound, such that the transition metal compound is maintained in a solid phase. However, the heat applied is at a temperature that enables a transition metal of the transition metal compound to separate from other portions and/or elements of the transition metal compound and sublimate (e.g., transition from a solid phase directly to a gaseous phase). As such, the transition metal of the transition metal compound then reacts with the oxide support material to generate the catalyst.

The reactor vessel 10 may include an inconel tube, a fluidized bed, a rotary furnace, and/or another suitable reactor that may be operated to perform a continuous process or a batch process. The reactor vessel 10 may include a heat source 18, such as a burner or furnace, a heat exchanger, a heating jacket, a radiator, a convection heater, a resistance heater, or another suitable heating element. The heat source 18 may be communicatively coupled to a control system 20 that includes memory 22 and a processor 24. The memory 22 may include non-transitory, machine readable media that is configured to store instructions executable by the processor 24. The instructions may be configured to adjust an amount of heat supplied to the reactor vessel 10 by the heat source 18, such that the heat source 18 enables the components within the reactor vessel 10 to be heated to various temperatures consistent with a thermal treatment procedure. For instance, the control system 20, via the processor 24, may adjust an amount of electrical power supplied to the heat source 18 to control a temperature within the reactor vessel 10 in accordance with a thermal treatment procedure for the solventless metal loading process. The instructions of the control system 20 may include multiple thermal treatment procedures for execution of the solventless metal loading process, which are described in the Examples listed below.

In some embodiments, the reactor vessel 10 may further be configured to receive a gaseous input 26 that facilitates mixing of components within the reactor vessel 10, facilitates the sublimation of the one or more transition metal compounds, enables a reaction to take place between the one or more transition metal compounds and the oxide support material, and/or facilitates activation of the catalyst. For instance, the gaseous input 26 may include an inert gas, such as nitrogen or argon, and/or may include an oxygen containing gas, such as air, blends of inert gas and oxidizing gas, and/or blends of inert gas and reducing gas. The gaseous input 26 may be introduced into the reactor vessel 10 during one or more of the thermal treatment procedures to facilitate mixing, cooling, a reaction, activation, or any combination thereof.

In any case, the catalyst product 12 may be removed from the reactor vessel 10 upon completion of the one or more thermal treatment procedures for the solventless metal loading process. In some embodiments, an additional transition metal compound (e.g., a precursor material having chromium) may be reacted with the catalyst product 12 in a separate reactor vessel before or after the metal loading process in the reactor vessel 10. The final catalyst product 12 may be directed to a polymerization reactor 28, which may include a batch, slurry, gas-phase, solution, high pressure, tubular, or autoclave reactor. Examples of gas phase reactors may include fluidized bed reactors and/or staged horizontal reactors. “Slurry” reactors may include horizontal and/or vertical loop reactors. “High pressure” reactors may include autoclave and/or tubular reactors. In any case, the polymerization reactor 28 may receive the catalyst product 12 and use the catalyst product 12 to facilitate a polymerization reaction to generate a polymer (e.g., polyethylene).

As set forth above, in some embodiments the one or more transition metal compounds may include titanocene dichloride, which may produce hydrochloric acid during the solventless metal loading process within the reactor vessel 10. As such, the reactor vessel 10 may include a scrubber 30 that is configured to remove the hydrochloric acid from the catalyst product 12 that is directed toward the polymerization reactor 28. In some embodiments, the reactor vessel 10 may also include a byproduct outlet 31 (e.g., a valve and/or a conduit) that enables byproducts of the solventless metal loading process to be removed from the reactor vessel 10. The byproduct outlet 31 may be selectively actuated to remove the byproducts from within the reactor vessel 10 based on a pressure within the reactor vessel 10, for example. Additionally or alternatively, the scrubber 30 may be utilized to remove offgas and/or the byproducts resulting from the solventless metal loading process. Accordingly, the catalyst product 12 may not include contaminants and/or other undesired products that may be present in the reactor vessel 10 to enable catalyst to generate a polymer having enhanced properties (e.g., an HLMI of greater than 30 g/10 min).

As set forth above, the catalyst product 12 may also be formed using a masterbatch process to facilitate generation of the catalyst product 12 in greater quantities. For example, FIG. 2 is a schematic of an embodiment of a system 32 that may be utilized to perform the masterbatch process disclosed herein. As illustrated in FIG. 2, the masterbatch composition (e.g., a masterbatch concentrate composition) is formed in a mixer 33. For example, the oxide support material and the one or more transition metal compounds are directed to the mixer 33 as inputs 34. The masterbatch composition is then directed to the reactor vessel 10 and mixed with bulk oxide support material 35 in the reactor vessel 10. The temperature of the mixture of the masterbatch composition and the bulk oxide support material 35 in the reactor vessel 10 is increased to facilitate the sublimation, redistribution and reaction of the one or more transition metal compounds with the oxide support material (e.g., silica). This increase in temperature may increase the temperature within the reactor vessel 10 to a temperature of between 100° C. and 300° C., between 120° C. and 250° C., or between 140° C. and 200° C. In some embodiments, as the temperature increases in the reactor vessel 10, the reactor vessel 10 may receive the gaseous input 26, which may be an oxidizing gas (e.g., dry air), an inert gas (e.g., dry nitrogen or argon), or a reducing gas (e.g., carbon monoxide or hydrogen). In other embodiments, as the temperature in the reactor vessel 10 increases, the reactor vessel 10 may be maintained as a vacuum. The result of the increase in temperature within the reactor vessel 10 is “pre-catalyst” 36. As illustrated in FIG. 2, the pre-catalyst 36 may contain essentially the same composition (e.g., essentially the same weight percent of the one or more transition metal compounds) as the final catalyst product 12. The composition of the pre-catalyst 36 (e.g., based on the “let-down” ratio) may determine the composition of the final catalyst product 12.

As illustrated in FIG. 2, after the pre-catalyst 36 is formed, it is then directed to a calcination vessel 37, which may be located at a different plant (e.g., a polyethylene plant used to polymerize ethylene) than a plant utilized to form the pre-catalyst 36. In any case, the calcination vessel 37 may include a fluidized bed calcining vessel. The temperature of the pre-catalyst 36 in the calcination vessel 37 is increased during fluidization to a relatively high temperature, such as greater than 500° C., greater than 600° C., greater than 700° C., or greater than 800° C. This fluidization within the calcination vessel 37 may be performed with an oxidizing gas, such as dry air. The product of the calcination vessel 37 after the increase in temperature is the final catalyst product 12.

A variation of the embodiment illustrated in FIG. 2 may include generating the masterbatch composition without a raw chromium containing compound. As such, the chromium containing compound may be impregnated with the oxide support material that is utilized to generate the masterbatch composition. Utilizing such a variation may reduce an amount of components and/or inputs 34 used for the masterbatch process.

In embodiments using the masterbatch process, such as the system 32 illustrated in FIG. 2, the masterbatch composition may include between 0 weight percent (wt %) and 90 wt %, between 10 wt % and 80 wt %, between 20 wt % and 70 wt %, between 30 wt % and 75 wt %, or between 10 wt % and 60 wt % of the oxide support material (e.g., silica).

The masterbatch composition may also include between 5 wt % and 90 wt %, between 10 wt % and 80 wt %, between 25 wt % and 75 wt %, or between 30 wt % and 70 wt % of the one or more transition metal compounds (e.g., titanocene dichloride). Further, the masterbatch composition may include between 0.5 wt % and 25 wt %, between 2 wt % and 25 wt %, between 5 wt % and 20 wt %, between 6 wt % and 15 wt %, or between 30 wt % and 60 wt % of a transition metal (e.g., titanium).

Further still, the masterbatch composition may include between 1 wt % and 40 wt %, between 5 wt % and 30 wt %, between 10 wt % and 20 wt %, or between 15 wt % and 25 wt % of the one or more transition metal compounds (e.g., chromium (III) acetylacetonate). Additionally or alternatively, the masterbatch composition may include between 1 wt % and 10 wt %, between 2 wt % and 5 wt %, between 3 wt % and 10 wt %, or between 4 wt % and 5 wt % of an additional transition metal (e.g., chromium).

As set forth above, the pre-catalyst is formed by dilution of the masterbatch composition with additional oxide support material (e.g., bulk oxide support material) followed by heating the mixture to a relatively low temperature. The “let-down ratio” may be defined as the number of units of oxide support material (e.g., silica and/or a silica chromium mixture) added per unit of the masterbatch composition to form the pre-catalyst. The let-down ratio may be between 0 and 40, between 1 and 35, between 2 and 30, between 3 and 25, between 4 and 20, or between 5 and 30.

After the masterbatch composition has been “let-down” via dilution with the additional oxide support material, the temperature within the reactor vessel 10 may be increased to initiate a thermal reaction that produces the pre-catalyst 36. In some embodiments, the temperature in the reactor vessel 10 may be increased to a temperature between 100° C. and 250° C., between 120° C. and 200° C., between 140° C. and 200° C., between 130° C. and 180° C., or between 125° C. and 175° C.

The pre-catalyst 36 may include between 50 wt % and 99 wt %, between 60 wt % and 98 wt %, between 70 wt % and 96 wt %, or between 75 wt % and 95 wt % of the oxide support material (e.g., silica).

Additionally, the pre-catalyst 36 may include between 0.1 wt % and 20 wt %, between, between 1 wt % and 15 wt %, between 2 wt % and 10 wt %, between 2 wt % and 5 wt %, or between 1.5 wt % and 6 wt % of a transition metal (e.g., titanium).

The pre-catalyst 36 may further include between 0.1 wt % and 20 wt %, between 0.2 wt % and 10 wt %, between 0.5 wt % and 7 wt %, or between 0.7 wt % and 5 wt % of an additional transition metal (e.g., chromium).

Further still, the pre-catalyst 36 may include between 0.1 wt % and 5 wt %, between 0.2 wt % and 3 wt %, or between 0.3 wt % and 2.5 wt % of a halide (e.g., chlorine).

Thus, in some embodiments, the pre-catalyst 36 includes between 0.5 wt % and 6 wt % titanium, between 0.1 wt % and 3.5 wt % chlorine, between 0 wt % and 3 wt % chromium, and greater than 80 wt % silica.

The amount of oxide support material (e.g., silica) in the final catalyst product 12 may be between 70 wt % and 99.5 wt %, between 80 wt % and 99 wt %, or between 82 wt % and 95 wt %.

The amount of transition metal (e.g., titanium) in the final catalyst product 12 may be between 0.1 wt % and 15 wt %, between 0.25 wt % and 10 wt %, between 0.5 wt % and 7 wt %, or between 1 wt % and 5 wt %.

The amount of additional transition metal (e.g., chromium) in the final catalyst product 12 may be between 0.1 wt % and 10 wt %, between 0.2 wt % and 8 wt %, between 0.5 wt % and 5 wt %, or between 0.8 wt % and 3 wt %.

In some embodiments, the pre-catalyst 36 directed into the calcination reactor 37 may be heated (e.g., in the presence of dry air) to a calcination temperature. The calcination temperature within the calcination reactor 37 may be between 500° C. and 900° C., between 600° C. and 870° C., between 650° C. and 750° C., or approximately (e.g., within 10% of, within 5% of, or within 1% of) 650° C.

In some embodiments, the final catalyst product 12 may include between 0.5 wt % and 6 wt % titanium, between 0.01 wt % and 2 wt % halide (e.g., chlorine), between 0.1 wt % and 3 wt % chromium, and greater than 88 wt % silica.

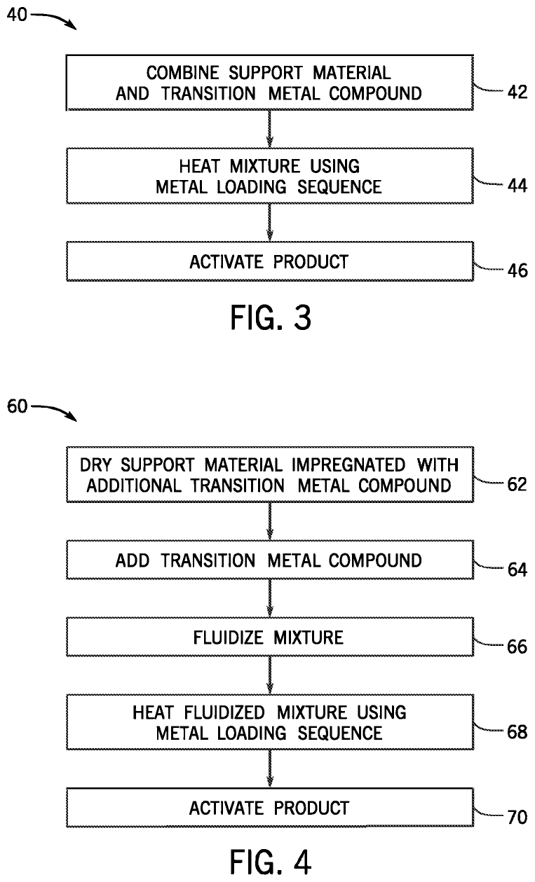

As set forth above, the control system 20 may control the heat source 18 to adjust a temperature within the reactor vessel 10. The memory 22 of the control system 20 may store instructions executable by the processor 24 that include the thermal treatment procedures for the solventless metal loading process. For example, FIG. 3 is a flow chart of an embodiment of a solventless metal loading process 40 for forming the catalyst product 12. As shown in FIG. 3, at block 42, the oxide support material may be combined and/or mixed with the one or more transition metal compounds in the reactor vessel 10. In some embodiments, the oxide support material and/or the one or more transition metal compounds may be directed through a sieve in order to generate a uniform particle size of the oxide support material and the one or more transition metal compounds. For example, the sieve may reduce a natural particle size (e.g., a particle size of a raw oxide support material and/or a raw transition metal compound) to a target particle size (e.g., 5-500 microns, 10-300 microns, 50-150 microns, or 50-100 microns) that is suitable for the solventless metal loading process 40. In a continuous process, the amount of the oxide support material directed into the reactor vessel 10 may be between 10 pounds per hour (lb/h) and 1000 lb/hr, or between 20 lb/hr and 100 lb/hr. In a continuous process where the reactor vessel 10 is a fluidized bed, the depth of the bed may be between 0.5 feet (ft) and 20 ft, between 1 ft and 10 ft, or between 3 ft and 8 ft. In a batch process, the amount of oxide support material inside the reactor vessel 10 may be between 0.1 pounds (lb) and 10,000 lb, between 10 lb and 5000 lb, or between 500 lb and 2000 lb. In either a continuous process or a batch process, the amount of the transition metal compound in the reactor vessel 10 and/or the amount of the masterbatch composition within the reactor vessel 10 is less than 50%, less than 30%, less than 20%, less than 10%, or less than 5% of the oxide support material. As set forth above, the oxide support material may include HA30W (e.g., a silica containing material).

Additionally, in the continuous process, the amount of the one or more transition metal compounds (e.g., a compound having titanium) directed to a calcination reactor vessel may be between 10 lb/hr and 300 lb/hr, between 10 lb/hr and 200 lb/hr, or between 10 lb/hr and 100 lb/hr.

In a batch process, the amount of the transition metal compound charged may be between 0.001 lb and 3000 lb, between 1 lb and 500 lb, between 10 lb and 200 lb, or between 25 lb and 100 lb.

In a batch process where the masterbatch composition is diluted with the oxide support material (e.g., silica and/or a silica and chromium containing compound), the amount of the masterbatch composition added may be between 10 lb and 3000 lb, between 25 lb and 500 lb, or between 50 lb and 200 lb. The amount of the one or more transition metal compounds depends on the amount of the oxide support material that is also charged. For example, the total amount of the one or more transition metal compounds and/or the masterbatch composition may be between 1 lb and 1000 lb, between 10 lb and 500 lb, or between 50 lb and 2000 lb.

Further still, the concentration of the one or more transition metal compounds and/or the masterbatch composition includes a target amount, such that a pre-catalyst and/or the final catalyst product includes between 0.1% and 10% by weight of a transition metal (e.g., from the one or more transition metal compounds and/or the masterbatch composition). The one or more transition metal compounds may include titanocene dichloride in the solid phase (e.g., a dry powder) and/or another suitable solid phase compound having titanium.

As set forth above, in some embodiments of the solventless metal loading process, an additional transition metal compound (e.g., a precursor material having a chromium containing compound and/or a compound having a transition metal different from the transition metal compound) may also be combined with the oxide support material and the one or more transition metal compounds in the reactor vessel 10. In such embodiments, the amount of the additional transition metal compound may be between 0.1% and 25%, between 0.5% and 15%, or between 1% and 10% of the oxide support material. Preferably, the amount of the additional transition metal compound may be approximately less than 25%, less than 15%, less than 10%, or less than 5% of the oxide support material. In other embodiments, the additional transition metal compound may be added to the reactor vessel 10 after a thermal treatment procedure is performed on the oxide support material and the one or more transition metal compounds. In any case, the materials disposed within the reactor vessel 10 may be substantially all (e.g., at least 90% by weight, at least 95% by weight, or at least 99% by weight) in a solid phase prior to undergoing the thermal treatment procedure.

At block 44 of FIG. 3, the mixture within the reactor vessel 10 (e.g., the oxide support material and the one or more transition metal compounds) may undergo a reaction or a metal loading sequence of the thermal treatment procedure. The metal loading sequence may be controlled by the control system 20, which may adjust a temperature within the reactor vessel 10 via the heat source 18. In some embodiments, the metal loading sequence may include increasing (e.g., ramping) a temperature within the reactor vessel at a target rate (e.g., a change in temperature over time). For example, in a batch process, a pre-catalyst formation and/or the metal loading sequence increases the temperature within the reactor vessel from room temperature (e.g., between 20° C. and 25° C.) to a temperature of approximately (e.g., within 10% of, within 5% of, or within 1% of) 140° C., a temperature less than 200° C., or a temperature less than 170° C. at a rate of between 0.1° C./minute and 10° C./minute, between 0.4° C./minute and 8° C./minute, or between 1° C./minute and 5° C./minute.

In a continuous process, the oxide support material and the one or more transition metal compounds move between heating zones of the reactor vessel 10 to increase the temperature of the oxide support material and the one or more transition metal compounds from room temperature to 140° C. or up to 200° C. to achieve an average heating rate of between 0.1° C./minute and 10° C./minute, between 0.4° C./minute and 8° C./minute, or between 1° C./minute and 5° C./minute within the heating zones. In some embodiments, the temperature within the reactor vessel 10 may be held at approximately 140° C. or up to 200° C. for a period of between 15 minutes to 3 hours, between 20 minutes and 2.5 hours, or between 1 hour and 2 hours. Increasing the temperature within the reactor vessel 10 during the metal loading sequence enables the one or more transition metal compounds to undergo sublimation and transition from a solid phase directly to a gaseous phase. The gaseous transition metal compound may then react with or otherwise be deposited or loaded on the oxide support material during the metal loading sequence.

In some embodiments, the gaseous input 26 may be directed into the reactor vessel 10 during the pre-catalyst formation and/or the metal loading sequence of the thermal treatment procedure. The gaseous input 26 may be directed into the reactor vessel 10 from below a bed that holds the oxide support material and the one or more transition metal compounds (e.g., in a fluidized bed reactor) and/or via an input that enables a horizontal flow of the gaseous input 26 (e.g., co-current or counter-current to movement of the oxide support material and the one or more transition metal compounds within the reactor vessel 10) into the reactor (e.g., in a rotary kiln). For example, the gaseous input 26 may include nitrogen, another inert gas (e.g., argon), a reducing gas, and/or an oxidizing gas that may reduce, block, and/or prevent oxidation of the materials within the reactor vessel 10. The gaseous input 26 may also be utilized to facilitate mixing of the components in the reactor vessel 10 during the metal loading sequence to maintain a uniform mixture within the reactor vessel 10 throughout the duration of the metal loading sequence.

The gaseous input 26 may be directed into the reactor vessel 10 at a linear flow rate of between 0.01 feet per second (ft/s) and 1 ft/s, 0.1 ft/s and 0.5 ft/s, or between 0.15 ft/s and 0.35 ft/s. Preferably, the flow rate of the gaseous input 26 may be approximately (e.g., within 10% of, within 5% of, or within 1% of) 0.25 ft/s. Further, the flow rate of the gaseous input 26 may be defined in terms of space velocity (e.g., velocity relating volumetric flow of the gaseous input 26 to a volume of the reactor vessel 10). In such embodiments, the space velocity of the gaseous input 26 may be between 0.001 beds per second (beds/s) and 1 beds/s, between 0.01 beds/s and 0.1 beds/s, or between 0.02 beds/s and 0.05 beds/s. In other embodiments, the gaseous input 26 may be not be introduced into the reactor vessel 10 during the metal loading sequence.

To ensure that substantially all (e.g., greater than 80%, greater than 90%, greater than 95%, or greater than 99%) of the transition metal compound sublimes and reacts with the oxide support material, the pre-catalyst formation and/or the metal loading sequence may include a second increase (e.g., ramp) in temperature. For instance, the temperature in the reactor vessel 10 may be increased from approximately 140° C. to between 145° C. and 250° C. at a rate of 0.1° C./minute and 10° C./minute, between 0.4° C./minute and 8° C./minute, or between 1° C./minute and 5° C./minute. In some embodiments, the temperature in the reactor vessel 10 is increased from 140° C. to approximately (e.g., within 10% of, within 5% of, or within 1% of) 150° C. and held at 150° C. for between 1 minute and 3 hours or between 15 minutes and 30 minutes. In other embodiments, the temperature in the reactor vessel 10 is increased from 140° C. to approximately (e.g., within 10% of, within 5% of, or within 1% of) 200° C. and held at 250° C. for between 25 minutes and 40 minutes.

As illustrated in FIG. 2, the “activation sequence” includes the final calcination step in the calcination vessel 37 to create the final catalyst product 12. The final catalyst product 12 may include over 80% of a total chromium composition as hexavalent chromium (i.e., Cr(VI)).

At block 46 of FIG. 3, the activation sequence (e.g., calcination sequence) of the thermal treatment procedure may be initiated (e.g., by the control system 20). The activation sequence may include further increasing the temperature within the reactor vessel 10 beyond the temperature utilized for the metal loading sequence (e.g., a temperature greater than the sublimation temperature of the one or more transition metal compounds). For example, the activation sequence may include increasing the temperature from 140° C., 150° C., and/or 200° C. to greater than 400° C., greater than 500° C., greater than 600° C., or greater than 700° C. at a rate of between 0.1° C./minute and 10° C./minute, between 0.5° C./minute and 5° C./minute, or between 1° C./minute and 3° C./minute. Preferably, the activation sequence includes increasing the temperature from 140° C., 150° C., and/or 200° C. to approximately 650° C. at a rate of approximately (e.g., within 10% of, within 5% of, or within 1% of) 1.4° C./minute. The temperature within the reactor vessel 10 may be held at approximately 650° C. for a period between 1 hours and 24 hours, between 4 hours and 15 hours, or between 5 hours and 10 hours. Preferably, the temperature in the reactor vessel 10 is held at approximately 650° C. for a period of approximately (e.g., within 10% of, within 5% of, or within 1% of) 8 hours. In some cases, the temperature within the reactor may be increased while introducing air as the gaseous input 26 during the activation sequence. As such, air may be introduced to the components within the reactor vessel 10 to interact with the loaded oxide support material and activate (e.g., calcine) the catalyst product.

To facilitate collection of the catalyst product, the activation sequence may further include a cooling phase where the temperature within the reactor is allowed to cool from approximately 650° C. to room temperature (e.g., between 20° C. and 25° C.) by interrupting the heat applied to the reactor vessel 10 by the heat source 18. During the cooling phase, the gaseous input 26 may be switched from air to nitrogen and/or another inert gas that facilitates cooling and blocks any further reactions from taking place within the reactor vessel 10. Upon completion of the activation phase, the catalyst product 12 may be directed to the polymerization reactor 28 to facilitate a polymerization reaction that forms a polymer (e.g., polyethylene). The polymer formed by the polymerization reactor may exhibit enhanced physical and/or chemical properties. For example, the polymer may include a high load melt index of greater than 30 g/10 min.

In some embodiments, the activation sequence includes reducing treatments that expose the catalyst to a reducing gas, such as carbon monoxide, hydrogen, a hydrocarbon vapor, or another suitable reducing gas. The reducing treatments may be performed during the temperature rise (e.g., increase or ramp), after a maximum temperature is reached, or during the cool-down cycle. For example, in some embodiments, during the activation sequence, the temperature of the catalyst is increased to a maximum temperature (e.g., between 500° C. and 900° C.) while in the presence of air or oxygen. The temperature of the catalyst may be held for a time period (e.g., between 1 minute and 30 hours) while maintaining exposure of the catalyst to the air or oxygen. During the cool down step, the temperature of the catalyst is reduced to a target temperature (e.g., between 250° C. and 500° C.) while exposed to air or oxygen. Once the temperature of the catalyst reaches the target temperature, the target temperature is held and the air or oxygen is removed and replaced with a reducing gas, such as carbon monoxide. After another hold period at the target temperature (e.g., between 1 minute and 8 hours), the reduced catalyst is then cooled in an inert atmosphere and ultimately recovered.

In other embodiments, the temperature of the catalyst is increased to the maximum temperature (e.g., between 500° C. and 900° C., between 600° C. and 870° C., or between 650° C. and 800° C.) while exposed to a reducing gas or an inert gas. The temperature of the catalyst may be held at the maximum temperature while exposed to the reducing gas or the inert gas for a hold period (e.g., between 1 minute and 30 hours, between 1 hour and 20 hours, or between 3 hours and 12 hours). While maintaining the catalyst in the reducing or inert atmosphere, the temperature of the catalyst is reduced to a second temperature, which is lower than the maximum temperature by at least 50° C., 100° C., 150° C., or 200° C. At the second temperature, the catalyst may be subjected to another hold period, in which the inert or reducing gas is replaced with an oxidizing gas (e.g., dry air or oxygen). The catalyst is held at the second temperature while in the presence of the oxidizing gas for a second hold period (e.g., between 1 minute and 10 hours, between 10 minutes and 8 hours, or between 30 minutes and 4 hours). The reducing treatments performed during the activation sequence may increase the melt index potential of the catalyst (e.g., increase the catalyst's ability to make high melt index polymer) by enabling the catalyst to produce polymer having a melt index that is 10%, 25%, 50%, or 100% greater than catalysts produced without such reducing treatments. The effect of the reducing treatments on the catalyst is exemplified by U.S. Pat. Nos. 4,177,162 and 4,182,815, which are incorporated by reference herein. The catalysts of the present disclosure are particularly sensitive to this type of activation sequence, producing large increases in melt index of polymers generated with the catalysts.

FIG. 4 is a flow chart of another embodiment of the solventless metal loading process 60 that may include a drying sequence when utilizing oxide support material that is soaked in water (e.g., to form the masterbatch composition) and/or otherwise includes moisture and/or other volatile materials. At block 62, oxide support material impregnated with the additional transition metal compound (e.g., a precursor material having a chromium containing compound) may be introduced into the reactor vessel 10 and undergo the drying sequence (e.g., before pre-catalyst formation and/or the metal loading sequence). The drying sequence may include receiving the oxide support material impregnated with the additional transition metal compound in the reactor vessel 10 via the inputs 16.

In other embodiments, such as though utilizing the masterbatch process, a pre-drying sequence may be performed on raw oxide support material and/or oxide support material having the additional transition metal compound before generation of the pre-catalyst 36. That is, the raw oxide support material and/or oxide support material having the additional transition metal compound may incur an increase in temperature to remove physisorbed water prior to formation of the pre-catalyst 36. For instance, the pre-drying sequence may include increasing a temperature within the reactor vessel 10 or another separate vessel to a pre-drying temperature that is between 100° C. and 300° C., between 150° C. and 250° C., between 175° C. and 225° C., greater than 100° C., greater than 120° C., greater than 150° C., or greater than 180° C. As such, physisorbed water, which may react with the one or more transition metal compounds (e.g., a compound having titanium), may be removed from the oxide support material and/or the oxide support material having the additional transition metal compound. During this pre-drying sequence, the temperature may be increased from approximately room temperature (e.g., between 20° C. and 25° C.) to the pre-drying temperature at a rate of between 0.1° C./minute and 10° C./minute, between 0.4° C./minute and 8° C./minute, or between 1° C./minute and 5° C./minute. In some embodiments, the gaseous input 26 may be directed into the reactor vessel during the pre-drying sequence. The gaseous input 26 may include nitrogen, argon, air, carbon monoxide, or another suitable gas.

Further, the drying sequence and/or the pre-drying sequence may include cooling the oxide support material and/or the additional transition metal compound within the reactor vessel 10 back to room temperature (e.g., between 20° C. and 25° C.). Accordingly, heat supplied to the reactor vessel 10 from the heat source 18 may be interrupted to enable the temperature within the reactor vessel 10 to decrease back to room temperature. In some embodiments, the gaseous input 26 may continue to be directed into the reactor vessel 10 as the reactor vessel 10 is cooling. In other embodiments, the gaseous input 26 may not be directed into the reactor vessel 10 as the reactor vessel 10 cools during the drying sequence. The drying sequence and/or the pre-drying sequence may undergo such cooling to enable the oxide support material to return to room temperature prior to the metal loading sequence. Adding the one or more transition metal compounds to the reactor vessel 10 when the oxide support material is at an increased temperature may cause the one or more transition metal compounds to melt and/or otherwise affect sublimation of a transition metal of the one or more transition metal compounds. Thus, in some embodiments, the oxide support material is cooled back to approximately (e.g., within 20% of, within 10% of, within 5% of, or within 1% of) room temperature to enable the metal loading sequence to effectively occur.

At block 64, the one or more transition metal compounds (e.g., titanocene dichloride) may be introduced into the reactor vessel 10 with the dried oxide support material (e.g., raw oxide support material and/or oxide support material impregnated with the additional transition metal compound). As set forth above, the one or more transition metal compounds may be directed into the reactor vessel 10 in a solid phase to enable the one or more transition metal compounds to undergo sublimation during the metal loading sequence.

At block 66, the mixture of the one or more transition metal compounds and the dried oxide support material, or the masterbatch composition and the bulk oxide support material as shown in FIG. 2, may be fluidized (e.g., introduced to a flow of gas to facilitate mixing) to generate uniformity of the mixture within the reactor vessel 10. For instance, in some embodiments, the reactor vessel 10 is a fluidized bed reactor that enables the gaseous input 26 to be directed toward a bottom portion of the reactor vessel 10, and thus, the gaseous input 26 flows upwards through the solid components within the reactor vessel 10 and causes the solid components within the reactor vessel 10 to mix. Fluidizing the mixture within the reactor vessel 10 generates a uniform mixture of the one or more transition metal compounds and the dried oxide support material. The gaseous input 26 utilized to fluidize the mixture may include nitrogen, argon, air, or another suitable gas. In some embodiments, fluidization of the mixture may include directing the gaseous input 26 into the reactor vessel at a flow rate of between 0.01 feet per second (ft/s) and 1 ft/s, 0.1 ft/s and 0.5 ft/s, or between 0.15 ft/s and 0.35 ft/s. Preferably, the flow rate of the gaseous input 26 may be approximately (e.g., within 10% of, within 5% of, or within 1% of) 0.25 ft/s. Further, the flow rate of the gaseous input 26 may be defined in terms of space velocity (e.g., velocity relating volumetric flow of the gaseous input 26 to a volume of the reactor vessel 10). In such embodiments, the space velocity of the gaseous input 26 may be between 0.001 beds per second (beds/s) and 1 beds/s, between 0.01 beds/s and 0.1 beds/s, or between 0.02 beds/s and 0.05 beds/s.

At block 68, the fluidized bed mixture of the one or more transition metal compounds and the dried oxide support material may undergo pre-catalyst formation, or the metal loading sequence, of the thermal treatment procedure. As set forth above, the pre-catalyst formation (e.g., metal loading sequence) may include increasing (e.g., ramping) the temperature within the reactor vessel 10 from room temperature (e.g., between 20° C. and 25° C.) to a temperature of approximately (e.g., within 10% of, within 5% of, or within 1% of) 140° C. at a rate of between 0.1° C./minute and 10° C./minute, between 0.4° C./minute and 8° C./minute, or between 1° C./minute and 5° C./minute for form the pre-catalyst 36. In some embodiments, the temperature within the reactor vessel 10 may be held at approximately 140° C. for a period of between 15 minutes to 3 hours, between 20 minutes and 2.5 hours, or between 1 hour and 2 hours. Increasing the temperature within the reactor vessel 10 during the metal loading sequence enables the one or more transition metal compounds to undergo sublimation and transition from a solid phase to a gaseous phase. The gaseous transition metal compound may then react with or otherwise be deposited or loaded onto the oxide support material during the metal loading sequence.

In some embodiments, the gaseous input 26 may be directed into the reactor vessel 10 during the metal loading sequence of the thermal treatment procedure. For example, the gaseous input 26 may include nitrogen and/or another inert gas (e.g., argon) that may reduce, block, and/or prevent oxidation of the materials within the reactor vessel 10. The gaseous input 26 may also be utilized to facilitate mixing of the components in the reactor vessel 10 during the metal loading sequence to maintain a uniform mixture within the reactor vessel 10 throughout the duration of the metal loading sequence. The gaseous input 26 may be directed into the reactor vessel 10 at a flow rate of between 0.01 feet per second (ft/s) and 1 ft/s, 0.1 ft/s and 0.5 ft/s, or between 0.15 ft/s and 0.35 ft/s. Preferably, the flow rate of the gaseous input 26 may be approximately (e.g., within 10% of, within 5% of, or within 1% of) 0.25 ft/s. Further, the flow rate of the gaseous input 26 may be defined in terms of space velocity (e.g., velocity relating volumetric flow of the gaseous input 26 to a volume of the reactor vessel 10). In such embodiments, the space velocity of the gaseous input 26 may be between 0.001 beds per second (beds/s) and 1 beds/s, between 0.01 beds/s and 0.1 beds/s, or between 0.02 beds/s and 0.05 beds/s.

Further still, in some embodiments, formation of the pre-catalyst 36 (e.g., the metal loading sequence) may include a second increase (e.g., ramp) in temperature. For instance, the temperature in the reactor vessel 10 may be increased from approximately 140° C. to between 145° C. and 250° C. at a rate of between 0.1° C./minute and 10° C./minute, between 0.4° C./minute and 8° C./minute, or between 1° C./minute and 5° C./minute. In some embodiments, the temperature in the reactor vessel 10 is increased from 140° C. to approximately (e.g., within 10% of, within 5% of, or within 1% of) 150° C. and held at 150° C. for between 15 minutes and 30 minutes. In other embodiments, during formation of the pre-catalyst 36 (e.g., the metal loading sequence), the temperature in the reactor vessel 10 is increased from 140° C. to approximately (e.g., within 10% of, within 5% of, or within 1% of) 200° C. and held at 200° C. for between 25 minutes and 40 minutes.

At block 70, the catalyst product within the reactor vessel 10 undergoes the activation sequence (e.g., calcination sequence) to activate the catalyst product, such that it may be utilized in the polymerization reactor 28. For example, the activation sequence may enable the final catalyst product to undergo further reactions (e.g., calcination) that enable the catalyst product to ultimately be used for facilitating a polymerization reactor. As set forth above, in some embodiments, the activation sequence includes increasing (e.g., ramping) the temperature within the reactor vessel 10 beyond the temperature utilized for the metal loading sequence (e.g., increased to a temperature greater than the sublimation temperature of the one or more transition metal compounds). A hold temperature of the activation sequence may be greater than 500° C., greater than 600° C., greater than 700° C., or greater than 800° C. For example, the activation sequence may include increasing the temperature from 140° C., 150° C., and/or 200° C. to approximately (e.g., within 10% of, within 5% of, or within 1% of) 650° C. at a rate of between 0.1° C./minute and 10° C./minute, between 0.5° C./minute and 5° C./minute, or between 1° C./minute and 3° C./minute. The temperature within the reactor vessel 10 may be held at approximately 650° C. for a period of between 1 hours and 25 hours, between 2 hours and 14 hours, or between 2.5 hours and 10 hours. In some cases, the temperature within the reactor may be increased while introducing air as the gaseous input 26 during the activation sequence. As such, air may be introduced to the components within the reactor vessel 10 to interact with the loaded oxide support material and activate (e.g., calcine) the catalyst product.

In some embodiments, the activation sequence may further include and/or be followed by a cooling phase where the temperature within the reactor is allowed to cool from approximately 650° C. to room temperature (e.g., between 20° C. and 25° C.) by interrupting the heat applied to the reactor vessel 10 by the heat source 18. During the cooling phase, the gaseous input 26 may be switched from air to nitrogen, another inert gas, and/or carbon monoxide to facilitate cooling and blocks any further reactions from taking place within the reactor vessel 10. Upon completion of the activation phase, the catalyst product 12 may be directed to the polymerization reactor 28 to facilitate a polymerization reaction that forms a polymer (e.g., polyethylene). The polymer formed by the polymerization reactor may exhibit enhanced physical and/or chemical properties. For example, the polymer may include a high load melt index of greater than 5 g/10 min, greater than 10 g/10 min, greater than 15 g/10 min, greater than 20 g/10 min, greater than 25 g/10 min, or greater than 30 g/10 min.

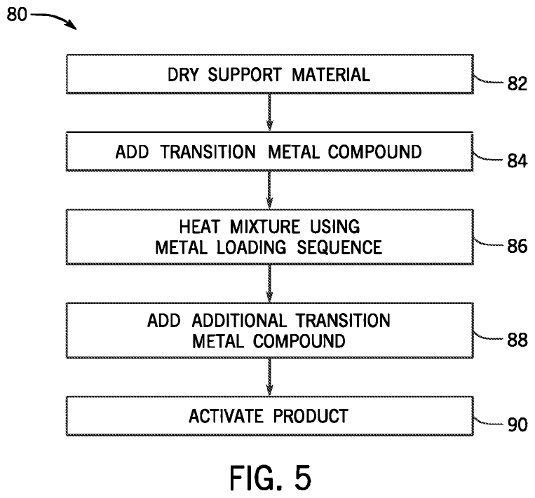

FIG. 5 is a flow chart of another embodiment of the solventless metal loading process 80 that introduces the additional transition metal compound (e.g., a precursor material having a chromium containing compound) into the reactor vessel after sublimation of the one or more transition metal compounds (e.g., after the metal loading sequence). For example, at block 82, raw oxide support material (e.g., HA30WS not impregnated with the additional transition metal compound) may undergo the drying sequence. In other embodiments, the solventless metal loading process 80 may not include the drying sequence, such that block 82 may not be performed. As set forth above, the drying sequence may include receiving the raw oxide support material in the reactor vessel 10 via the inputs 16. The drying sequence may be a portion of the thermal treatment procedure that is carried out before the metal loading sequence. For instance, the drying sequence may include increasing (e.g., ramping) a temperature within the reactor vessel 10 to a drying temperature that is between 100° C. and 300° C., between 150° C. and 250° C., or between 175° C. and 225° C. During the drying sequence, the temperature may be increased from approximately room temperature (e.g., between 20° C. and 25° C.) to the drying temperature at a rate of between 0.1° C./minute and 10° C./minute, between 0.4° C./minute and 8° C./minute, or between 1° C./minute and 5° C./minute. In some embodiments, the gaseous input 26 may be directed into the reactor vessel 10 during the drying sequence. The gaseous input 26 may include nitrogen, argon, air, or another suitable gas.

Further, the drying sequence may include cooling the raw oxide support material within the reactor vessel 10 back to room temperature (e.g., between 20° C. and 25° C.). Accordingly, heat supplied to the reactor vessel 10 from the heat source 18 may be interrupted to enable the temperature within the reactor vessel 10 to decrease back to room temperature. In some embodiments, the gaseous input 26 may continue to be directed into the reactor vessel 10 as the reactor vessel 10 is cooling. In other embodiments, the gaseous input 26 may not be directed into the reactor vessel 10 as the reactor vessel 10 cools during the drying sequence. The drying sequence may undergo such cooling to enable the oxide support material to return to room temperature prior to the metal loading sequence. Adding the one or more transition metal compounds to the reactor vessel 10 when the oxide support material is at an increased temperature may cause the one or more transition metal compounds to melt and/or otherwise affect sublimation of a transition metal of the one or more transition metal compounds. Thus, the oxide support material is cooled back to approximately (e.g., within 20% of, within 10% of, within 5% of, or within 1% of) room temperature to enable the metal loading sequence to effectively occur.

At block 84, the one or more transition metal compounds may be added to the reactor vessel 10 via the inputs 16. As set forth above, the one or more transition metal compounds may be directed into the reactor vessel 10 in a solid phase to enable the one or more transition metal compounds to undergo sublimation during the metal loading sequence.

At block 86, the mixture of the one or more transition metal compounds and the raw oxide support material undergo the metal loading sequence. As set forth above, the metal loading sequence may include increasing (e.g., ramping) the temperature within the reactor vessel 10 from room temperature (e.g., between 20° C. and 25° C.) to a temperature of approximately (e.g., within 10% of, within 5% of, or within 1% of) 140° C. at a rate of between 0.1° C./minute and 10° C./minute, between 0.4° C./minute and 8° C./minute, or between 1° C./minute and 5° C./minute. In some embodiments, the temperature within the reactor vessel 10 may be held at approximately 140° C. for a period of between 15 minutes to 3 hours, between 20 minutes and 2.5 hours, or between 1 hour and 2 hours. Increasing the temperature within the reactor vessel 10 during the metal loading sequence enables the one or more transition metal compounds to undergo sublimation and transition from a solid phase to a gaseous phase. The gaseous transition metal compound may then react with or otherwise be deposited or loaded onto the oxide support material during the metal loading sequence.

In some embodiments, the gaseous input 26 may be directed into the reactor vessel 10 during the metal loading sequence of the thermal treatment procedure. For example, the gaseous input 26 may include nitrogen and/or another inert gas (e.g., argon) that may reduce, block, and/or prevent oxidation of the materials within the reactor vessel 10. The gaseous input 26 may also be utilized to facilitate mixing of the components in the reactor vessel 10 during the metal loading sequence to maintain a uniform mixture within the reactor vessel 10 throughout the duration of the metal loading sequence. The gaseous input 26 may be directed into the reactor vessel 10 at a flow rate of between 0.01 feet per second (ft/s) and 1 ft/s, 0.1 ft/s and 0.5 ft/s, or between 0.15 ft/s and 0.35 ft/s. Preferably, the flow rate of the gaseous input 26 may be approximately (e.g., within 10% of, within 5% of, or within 1% of) 0.25 ft/s. Further, the flow rate of the gaseous input 26 may be defined in terms of space velocity (e.g., velocity relating volumetric flow of the gaseous input 26 to a volume of the reactor vessel 10). In such embodiments, the space velocity of the gaseous input 26 may be between 0.001 beds per second (beds/s) and 1 beds/s, between 0.01 beds/s and 0.1 beds/s, or between 0.02 beds/s and 0.05 beds/s. In other embodiments, the gaseous input 26 may be not be introduced into the reactor vessel 10 during the metal loading sequence.

Further still, in some embodiments, the metal loading sequence may include a second increase (e.g., ramp) in temperature. For instance, the temperature in the reactor vessel 10 may be increased from approximately 140° C. to between 145° C. and 250° C. at a rate of between 0.1° C./minute and 10° C./minute, between 0.4° C./minute and 8° C./minute, or between 1° C./minute and 5° C./minute. In some embodiments, the temperature in the reactor vessel 10 is increased from 140° C. to approximately (e.g., within 10% of, within 5% of, or within 1% of) 150° C. and held at 150° C. for between 15 minutes and 30 minutes. In other embodiments, the temperature in the reactor vessel 10 is increased from 140° C. to approximately (e.g., within 10% of, within 5% of, or within 1% of) 200° C. and held at 200° C. for between 25 minutes and 40 minutes.

At block 88, the additional transition metal compound (e.g., a precursor material having a chromium containing compound) may be directed into the reactor vessel 10 via the inputs 16. The additional transition metal compound may be introduced in a solid phase (e.g., a dry powder) into the reactor vessel 10 and mixed with the loaded oxide support material (e.g., via mechanical mixing and/or mixing with caused by the gaseous input 26).

At block 90, the mixture of the loaded oxide support material and the additional transition metal compound may undergo the activation sequence (e.g., calcination sequence). As set forth above, the activation sequence includes increasing the temperature from 140° C., 150° C., and/or 200° C. to greater than 400° C., greater than 500° C., greater than 600° C., or greater than 700° C. at a rate of between 0.1° C./minute and 10° C./minute, between 0.5° C./minute and 5° C./minute, or between 1° C./minute and 3° C./minute. The temperature within the reactor vessel 10 may be held at approximately 650° C. for a period between 1 hours and 5 hours, between 2 hours and 4 hours, or between 2.5 hours and 3.5 hours. In some cases, the temperature within the reactor may be increased while introducing air as the gaseous input 26 during the activation sequence. As such, air may be introduced to the components within the reactor vessel 10 to interact with the loaded oxide support material and activate (e.g., calcine) the ultimate catalyst product.

In some embodiments, the activation sequence may further include a cooling phase where the temperature within the reactor is allowed to cool from approximately 650° C. to room temperature (e.g., between 20° C. and 25° C.) by interrupting the heat applied by the heat source 18. During the cooling phase, the gaseous input 26 may be switched from air to nitrogen and/or another inert gas that facilitates cooling and blocks any further reactions from taking place within the reactor vessel 10. Upon completion of the activation phase, the catalyst product 12 may be directed to the polymerization reactor 28 to facilitate a polymerization reaction that forms a polymer (e.g., polyethylene). The polymer formed by the polymerization reactor may exhibit enhanced physical and/or chemical properties. For example, the polymer may include a high load melt index of greater than 30 g/10 min.

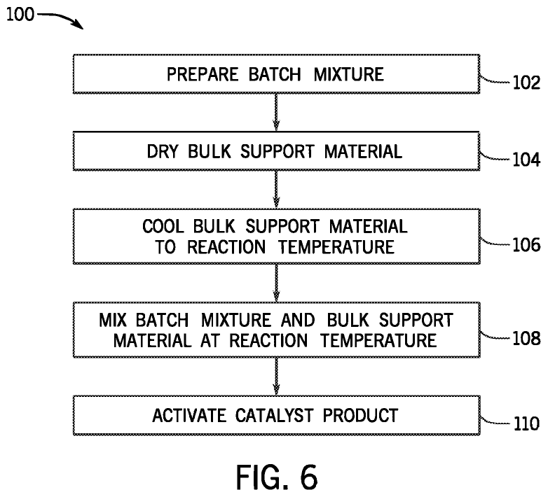

FIG. 6 is a flow chart of an embodiment of a masterbatch process 100 for performing the solventless metal loading process. As set forth above, the masterbatch process 100 may facilitate scaling and/or production of the catalyst product. For instance, the masterbatch process 100 includes pre-forming a masterbatch composition that includes target amounts of the oxide support material and the one or more transition metals. The masterbatch composition may be placed in a storage vessel and added to a bulk oxide support material in response to a demand for the catalyst product. At block 102, a masterbatch composition may be prepared by combining the oxide support material, the transition metal compound, and the additional transition metal compound. In some embodiments, the masterbatch composition may include between 1 weight percent (wt %) and 60 wt %, between 5 wt % and 50 wt %, between 10 wt % and 60 wt %, or between 5 wt % and 30 wt % of the oxide support material (e.g., a silica support material and/or raw oxide support material without being impregnated with the additional transition metal compound). The masterbatch composition may also include between 30 wt % and 60 wt %, between 35 wt % and 50 wt %, or between 40 wt % and 45 wt % of the transition metal compound (e.g., titanocene dichloride). Additionally, the masterbatch composition may include between 5 wt % and 30 wt %, between 8 wt % and 25 wt %, or between 10 wt % and 20 wt % of the additional transition metal compound (e.g., a chromium compound, such as chromium acetylacetonate). It should be noted that the transition metal compound and/or the additional transition metal compound may not include a pure transition metal. As such, the weight percentages of the pure transition metal are less than those set forth above.

In some embodiments, the masterbatch composition may be directed through a sieve to enable a particle size of each component of the masterbatch composition to be substantially uniform. As set forth above, each component (e.g., the oxide support material, the transition metal compound, and the additional transition metal compound) may be in a solid phase when directed into the reactor vessel 10. As such, the masterbatch composition may be directed through a sieve (e.g., a #40 sieve that includes openings having a diameter of 420 microns) that may reduce a particle size of one or more of the components and enable a uniform particle size of the masterbatch composition before the masterbatch composition is directed into the reactor vessel 10.

At block 104, bulk oxide support material (e.g., raw oxide support material or bulk silica), separate from the raw oxide support material of the masterbatch composition, may be introduced into the reactor vessel 10. The bulk oxide support material may then undergo the drying sequence. For instance, the drying sequence may include increasing a temperature within the reactor vessel 10 to a drying temperature that is between 100° C. and 300° C., between 150° C. and 250° C., or between 175° C. and 225° C. During the drying sequence, the temperature may be increased from approximately room temperature (e.g., between 20° C. and 25° C.) to the drying temperature at a rate of between 0.1° C./minute and 10° C./minute, between 0.4° C./minute and 8° C./minute, or between 1° C./minute and 5° C./minute. In some embodiments, the gaseous input 26 may be directed into the reactor vessel during the drying sequence. The gaseous input 26 may include nitrogen, argon, air, or another suitable gas.

At block 106, the bulk oxide support material may be cooled to a reaction temperature and the masterbatch composition may then be added to the reactor vessel 10, at block 108. In some embodiments, the reaction temperature may be between 100° C. and 200° C., between 110° C. and 180° C., or between 130° C. and 150° C. Additionally, the bulk oxide support material and the masterbatch composition may be fluidized via the gaseous input 26. For example, the gaseous input 26 may include nitrogen and may be utilized to uniformly mix the bulk oxide support material with the masterbatch composition. In some embodiments, the fluidized bulk oxide support material and masterbatch composition may be held at the reaction temperature for a period of time, such as between 10 minutes and 2 hours, between 15 minutes and 1.5 hours, or between 20 minutes and 40 minutes. In other embodiments, the fluidized bulk oxide support material and the masterbatch composition may be fluidized and then the process 100 may proceed to block 110.

At block 110, the fluidized mixture undergoes the activation sequence (e.g., calcination), as set forth above. For example, the activation sequence includes increasing the temperature from the reaction temperature to greater than 400° C., greater than 500° C., greater than 600° C., or greater than 700° C. at a rate of between 0.1° C./minute and 10° C./minute, between 0.5° C./minute and 5° C./minute, or between 1° C./minute and 3° C./minute. The temperature within the reactor vessel 10 may be held at approximately 650° C. for a period between 1 hours and 5 hours, between 2 hours and 4 hours, or between 2.5 hours and 3.5 hours. In some cases, the temperature within the reactor may be increased while introducing air and/or nitrogen as the gaseous input 26 during the activation sequence.

In some embodiments, the activation sequence may further include a cooling phase where the temperature within the reactor is allowed to cool from approximately 650° C. to room temperature (e.g., between 20° C. and 25° C.) by interrupting the heat applied by the heat source 18. During the cooling phase, the gaseous input 26 may continue to be directed into the reactor vessel 10 to facilitate cooling of the components within the reactor vessel 10. Upon completion of the activation phase, the catalyst product 12 may be directed to the polymerization reactor 28 to facilitate a polymerization reaction that forms a polymer (e.g., polyethylene). The polymer formed by the polymerization reactor may exhibit enhanced physical and/or chemical properties. For example, the polymer may include a high load melt index of greater than 30 g/10 min.

For example, in the polymerization reactor 28, the catalyst product 12 may be combined with a diluent (e.g., isobutane) and heated and/or pressurized to a target temperature and target pressure. The target temperature may be between 50° C. and 250° C., between 75° C. and 150° C., or between 100° C. and 120° C. A monomer (e.g., ethylene) and/or a comonomer may be added to the polymerization reactor 28 once the catalyst product and diluent reach the target temperature and target pressure. Monomer and/or comonomer may continue to be fed into the polymerization reactor 28 to maintain the polymerization reactor 28 at the target pressure. Ultimately, polymer product, or “fluff,” may then be collected and processed.

The polymer product (e.g., polyethylene) may be formed into pellets, which can be used in the manufacture of a variety of products, components, household items and other items, electrical wire and cable, agricultural films, shrink film, stretch film, food packaging films, flexible food packaging, milk containers, frozen-food packaging, trash and can liners, grocery bags, heavy-duty sacks, plastic bottles, safety equipment, coatings, toys, and an array of containers and plastic products. Further, the products and components formed from the polymer pellets may be further processed and assembled prior to distribution and sale to the consumer. For example, the polymer pellets are generally subjected to further processing, such as blow molding, injection molding, rotational molding, blown film, cast film, extrusion (e.g., sheet extrusion, pipe and corrugated extrusion, coating/lamination extrusion, etc.), and so on. Products produced using these polymer pellets may, in some cases, be recycled.

### EXAMPLES

The following examples are given as particular embodiments of the present disclosure to demonstrate the practice and advantages thereof. It is understood that the examples are given by way of illustration and are not intended to limit the specification of the claims to follow in any manner.

It has been discovered that forming catalysts using the solventless metal loading process may lead to catalysts having a more uniform dispersion of transition metal compound on the oxide support material when compared to metal loading processes that utilize solvents. These catalysts may decrease reaction times of a polymerization reaction and/or increase production of the polymerization reaction by reducing an amount of unreacted components. The catalysts also produce polymers having enhanced properties, and particularly, that the polymers include a high load melt index (HLMI) greater than 30 g/10 min.

### Example 1

Example 1 relates to a metal loading process that utilizes solvents as a comparison to other Examples that use the solventless metal loading process of the present disclosure. In Example 1, 2 grams (g) of titanocene dichloride was taken up in approximately 35 milliliters (mL) of water and filtered through filter paper onto 10 g of silica (HA30WS) that was pre-impregnated with 1 wt % chromium. This slurry was mixed and dried in a glass dish over 2 days. The dried mixture was then activated via a standard air activation process to generate the catalyst product that contains more than 80% of total chromium as hexavalent chromium and that that may ultimately be supplied to a polymerization reactor. As used herein, the standard air activation process includes disposing the pre-catalyst and/or catalyst product into a vertical quartz tube, supported by a quartz frit, and passing air through the vertical quartz tube at a rate of 0.5 feet per second (ft/s). The temperature of the vertical quartz tube is then increased from room temperature to 650° C. at a rate of 4° C./minute. Upon reaching 650° C., the temperature of the vertical quartz tube is maintained at 650° C. for 3 hours and then allowed to cool to room temperature. As the temperature reduces, nitrogen is introduced into the vertical quartz tube at a temperature of 200° C. Once the temperature reduces to room temperature, the final catalyst is activated and collected from the vertical quartz tube.

### Examples 2 and 3

Examples 2 and 3 are directed to the solventless metal loading process of the present disclosure that includes performing the drying sequence on pre-impregnated oxide support material (e.g., before the metal loading sequence). In Examples 2 and 3, 10 g of silica (HA30WS) pre-impregnated with 1 wt % chromium was placed in a quartz tube supported by a quartz fit. The temperature of the quartz tube was increased from room temperature to 200° C. at a rate of 4° C./minute under a flow of nitrogen. The quartz tube was then brought to room temperature and 1.82 g of titanocene dichloride was added as a dry powder and fluidized with the pre-impregnated silica using nitrogen at a flow rate of 1.9 SCFH. The mixture of the pre-impregnated silica and titanocene dichloride was then heated to 140° C. under nitrogen flow. The temperature was then held at 140° C. for 1 hour. The temperature of the quartz tube was then raised to 150° C. and held at 150° C. for 2 hours. The quartz tube was then heated to 200° C. at a rate of 0.5° C./minute and held at 200° C. for 30 minutes. After the 30 minutes, the nitrogen flow was switched to a flow of air, and the temperature of the quartz tube was increased to 650° C. to perform the standard air activation process set forth above in Example 1. After the standard air activation process, the catalyst product was generated for use in a polymerization reactor.

### Example 4

Example 4 is directed to the solventless metal loading process of the present disclosure that includes performing the drying sequence on raw oxide support material (e.g., before the metal loading sequence). In Example 4, 10.1 g of silica (HA30WS) was dried in a vertical quartz tube, supported by a quartz frit. The silica was dried by increasing the temperature of the vertical quartz tube to 140° C. at rate of 10° C./minute under a flow of nitrogen at a flow rate of 1.5 SCFH. The temperature was then increased from 140° C. to 200° C. at rate of 2° C./minute under a flow of nitrogen at the flow rate of 1.5 SCFH. The temperature of the vertical quartz tube was held at 200° C. for 3 hours and then cooled to room temperature under the flow of nitrogen at the flow rate of 1.5 SCFH. After cooling, 1.84 g of titanocene dichloride was added as a dry powder to the dried silica in the vertical quartz tube. The mixture of dried silica and titanocene dichloride was heated to 140° C. at rate of 6° C./minute under the flow of nitrogen at the flow rate of 1.5 SCFH. The mixture of dried silica and titanocene dichloride was then heated from 140° C. to 200° C. at a rate of 0.5° C./minute and held at 200° C. for 30 minutes. The flow of nitrogen was increased to 2.0 SCFH, and the vertical quartz tube was cooled to room temperature. 0.67 g of chromium (III) acetylacetonate (Cr(AcAc)₃) was added to the vertical quartz tube as a dry finely pulverized powder. This mixture was then activated via the standard air activation process set forth above in Example 1. After the standard air activation process, the catalyst product was generated for use in a polymerization reactor.

### Examples 5-7

Examples 5-7 are directed to the solventless metal loading process of the present disclosure that includes impregnating the oxide support material and performing the drying sequence on the impregnated oxide support material (e.g., before the metal loading sequence). In Examples 5-7, 10 g of silica (HA30WS) was impregnated with 10 mL solution of basic chromium (III) acetate (approximately Cr₃(OH)₂(OOCCH₃)₇) in methanol to yield a silica with 1 wt % chromium. The silica-chromium compound was dried at room temperature for 3 hours. 1.8 g of titanocene dichloride was mixed into the silica-chromium compound by passing the titanocene dichloride and the silica-chromium compound through a sieve. The mixture was then heated to 200° C. in a quartz tube at rate of 1° C./minute and under a flow of nitrogen. The temperature of the mixture was held at 200° C. for 30 minutes and then the flow of nitrogen was switched to a flow of air. The catalyst was subsequently activated via the standard air activation process set forth above in Example 1. After the standard air activation process, the catalyst product was generated for use in a polymerization reactor.

### Example 8

The same procedure was used as in Examples 5-7, except that the silica-chromium compound was dried in a quartz tube at 200° C. for 3 hours prior to being mixed with the titanocene dichloride. The mixture was then heated to 200° C. at a rate of 1° C./minute under a flow of nitrogen. The temperature was held at 200° C. for 30 minutes and then the flow of nitrogen was switched to a flow of air. The catalyst was subsequently activated via the standard air activation process set forth above in Example 1. After the standard air activation process, the catalyst product was generated for use in a polymerization reactor.

### Example 9

Example 9 is directed to the solventless metal loading process of the present disclosure that includes performing the drying sequence on raw oxide support material (e.g., before the metal loading sequence). In Example 9, 10 g of silica (HA30WS) was pre-dried at 200° C. for 2 hours in a quartz tube support by a quartz fit under a flow of nitrogen. 1.91 g of titanium oxyacetylacetonate was added to the quartz tube as a powder. The mixture was heated to 500° C. at a rate of 5° C./minute under the flow of nitrogen having a flow rate of 1.5 SCFH. The temperature was then held at 500° C. for 2 hours. The temperature was then cooled to room temperature and the flow of nitrogen was switched to a flow of air. 0.7 g of finely pulverized chromium (III) acetylacetonate (Cr(AcAc)₃) was added to the quartz tube and the mixture was activated via the standard air activation as set forth above in Example 1. After the standard air activation process, the catalyst product was generated for use in a polymerization reactor.

### Example 10

The same procedure was used as in Example 9 except the mixture of silica and titanium oxyacetylacetonate was heated to a temperature of 650° C. instead of 500° C.

### Example 11

The same procedure was used as in Example 9 except the mixture of silica and titanium oxyacetylacetonate was heated to a temperature of 850° C. instead of 500° C.

### Example 12

The same procedure was used as in Example 11 except no titanium oxyacetylacetonate was added. Accordingly, Example 12 relates to forming a catalyst that does not include titanium.

### Example 13

The same procedure was used as in Example 11 except that after heating the mixture to 850° C. humid air was bubbled through the quartz tube at room temperature for 6 hours using a gas bubbler.

### Example 14

Example 14 relates to forming a catalyst that does not include titanium. In Example 14, 15 g of silica (HA30WS) pre-impregnated with 0.5 wt % chromium was heated to a temperature of 850° C. at a rate of 6° C./minute under a flow of nitrogen. The temperature was then held at 850° C. for 2 hours. The temperature of the reactor vessel was then reduced to 250° C. and the flow of nitrogen was replaced with a flow of air. The standard air activation process was then performed as set forth in Example 1. After the standard air activation process, the catalyst product was generated for use in a polymerization reactor.

### Example 15

This example relates to the masterbatch process described above. A masterbatch composition was prepared by mixing 2 g of silica (HA30WS), 1.8 g of titanocene dichloride in powder form, and 0.67 g of chromium (III) acetylacetonate (Cr(AcAc)₃) in powder form. The masterbatch composition was directed through a #40 sieve to generate a free flowing, uniformly mixed red/brown powder. A bulk silica (e.g., raw oxide support material) was prepared by placing 8 g of silica (HA30WS) into an activator tube, fluidizing the silica in nitrogen, and heating the activator tube in a furnace to 200° C. and holding the temperature at 200° C. for 1 hour. The bulk silica was then taken out of the furnace and cooled to 140° C. Upon cooling of the bulk silica to approximately 140° C., the masterbatch composition was added to the activator tube over a period of 30 seconds and the masterbatch composition and bulk silica was fluidized under a flow of nitrogen. The activator tube was then placed back into the furnace and heated to 140° C. at rate of 10° C./minute under a flow of nitrogen. The activator tube was then heated to 200° C. at a rate of 2° C./minute. The temperature of the activator tube was held at 200° C. for 30 minutes. The temperature of the activator tube was then increased to 550° C. at a rate of 4° C./minute under a flow of nitrogen. At 550° C., the flow of nitrogen flow was switched to a flow of air over a period of 5 minutes. The temperature of the activator tube was further increased to 650° C. at a rate of 4° C./minute. The temperature was held at 650° C. for 3 hours under the flow of air. The catalyst was harvested after cooling the activator tube to 200° C. and switching the flow of air to a flow of nitrogen.

Table 1 below provides various information related to the specific procedures of the above examples, properties and characteristics of the catalyst product, as well as properties and characteristics of the polymer produced using the catalyst product. As can be seen by the results of Table 1, the polymer produced using the solventless metal loading process with titanocene dichloride (e.g., Examples 2-8 and 15) mostly included a high load melt flow index (HLMI) of above 30 g/10 min.

| | | Ti | Act. | Run | | | | | | | | | |
|---|---|---|---|---|---|---|---|---|---|---|---|---|---|
| | Cr | wt % | T | T | Charge | Yield | Ind T | Prod | Act | HLMI | I10 | MI | |
| Example | wt % | (target) | (° C.) | (min) | (g) | (g) | (min) | (g/g) | (g/g/h) | (g/10 min) | (g/10 min) | (g/10 min) | Shear |
| 1 | 1 | 3.5 | 650 | 105 | 0.0936 | 269 | 7 | 2874 | 2078 | 30.8 | 6.1 | 0.3 | 96.3 |
| 2 | 1 | 3.5 | 650 | 105 | 0.0997 | 270 | 12 | 2708 | 4779 | 39.1 | 7.9 | 0.5 | 86.7 |
| 3 | 1 | 3.5 | 650 | 105 | 0.0792 | 221 | 12 | 2790 | 4406 | 33.1 | 6.8 | 0.4 | 83.5 |
| 4 | 1 | 3.5 | 650 | 105 | 0.0942 | 277 | 5 | 2941 | 2485 | 39.4 | 7.9 | 0.5 | 85.6 |
| 5 | 1 | 3.5 | 650 | 105 | 0.0966 | 259 | 6 | 2681 | 1915 | 38.1 | 7.9 | 0.5 | 82.8 |
| 6 | 1 | 3.5 | 650 | 105 | 0.0846 | 235 | 11 | 2778 | 1894 | 37.0 | 6.9 | 0.4 | 84.1 |
| 7 | 1 | 3.5 | 650 | 105 | 0.0693 | 194 | 6 | 2799 | 1931 | 22.9 | 2.7 | 0.2 | 99.6 |
| 8 | 1 | 3.5 | 650 | 105 | 0.0672 | 175 | 7 | 2604 | 1645 | 37.3 | 7.4 | 0.4 | 86.7 |
| 9 | 1 | 3.5 | 650 | 105 | 0.0703 | 196 | 12 | 2788 | 2835 | 8.7 | 1.4 | — | — |
| 10 | 1 | 3.5 | 650 | 105 | 0.0805 | 273 | 6 | 3391 | 2731 | 14.6 | 2.5 | — | — |
| 11 | 1 | 3.5 | 650 | 105 | 0.0784 | 227 | 7 | 2895 | 3048 | 101.8 | 20.1 | 1.3 | 76.5 |
| 12 | 1 | 0 | 650 | 105 | 0.0767 | 216 | 10 | 2816 | 3313 | 51.2 | 9.8 | 0.4 | 119.0 |
| 13 | 1 | 3.5 | 650 | 105 | 0.0787 | 225 | 10 | 2859 | 3237 | 75.9 | 14.6 | 0.8 | 92.5 |
| 14 | 0.5 | 0 | 650 | 105 | 0.1219 | 303 | 25 | 2486 | 2528 | 21.7 | 3.8 | — | — |
| 15 | 1 | 3.5 | 650 | 105 | 0.104 | 288 | 10 | 2769 | 2077 | 34.7 | 7.3 | 0.4 | 80.7 |

### Example 16

Using the same methods described above, two catalysts were made by first drying a sample of HA30WS silica at approximately 200° C. for 3 hours. This silica was dry-mixed with titanocene dichloride, such that the resulting mixture included 3.5 wt % titanium. The mixture was then heated under nitrogen to 140° C. at 6° C./minute, heated to 200° C. at 0.5° C./minute, and held at 200° C. for 30 minutes. After cooling, this material was analyzed by X-ray fluorescence (“XRF”), which indicated that the two samples contained 4.029 wt % and 4.007 wt % titanium as the oxide. These samples were then dry mixed with chromium (III) acetylacetonate, to generate a mixture having approximately 1 wt % chromium. This mixture was then calcined in dry air at 650° C. for 3 hours. The resulting products were also analyzed by XRF and the results are shown below in Table 2.

These final catalysts were then tested in a polymerization reaction, as described above. The results of the polymerization reaction are also listed in Table 2 below. Note that these final catalysts produced good activity and the polymer had high HLMI (e.g., above 30 g/10 min or 30 dg/min).

### Example 17

Still another example was carried out as described above and with HA30WS silica. However, in this example, the chromium was deposited onto the silica at the same time as the titanium. This was accomplished by drying 10 g of silica in a vacuum oven overnight at 100° C. and then adding 1.82 g of titanocene dichloride and 0.67 g of chromium (III) acetylacetonate. This mixture was placed into a quartz tube with a frit and heated immediately to 100° C. and then to 300° C. at 1° C./minute under 2 scfm of nitrogen flow. The temperature of the mixture was held at 300° C. of 15 minutes. The mixture was cooled and the sample for the pre-catalyst XRF analysis was taken at this point, and the results are shown in Table 2. The mixture was heated to 650° C. at 4° C./minute and held at 650° C. for 3 hours in air. Upon cooling to room temperature, the final catalyst was harvested and a sample was sent for XRF analysis, the results of which are shown in Table 2.

TABLE 2
XRF and other data from Examples 16 and 17

| | Example= | 16A | 16B | 17 |
|---|---|---|---|---|
| Pre-Catalyst | XRF % Cr | 0 | 0 | 1.13 |
| | XRF % Ti | 4.03 | 4.01 | 4.12 |
| | XRF % SiO2 | 91.11 | 91.47 | 89.08 |
| | XRF % Cl | 1.91 | 1.65 | 2.19 |
| Final Catalyst | XRF % Cr | 1.37 | 1.32 | 1.21 |
| | XRF % Ti | 3.99 | 4.09 | 4.15 |
| | XRF % SiO2 | 90.83 | 90.77 | 90.64 |
| | XRF % Cl | 0.23 | 0.27 | 0.45 |
| Activity | g/g/h | 2485 | 2570 | 2460 |
| MI | dg/min | 0.46 | 0.46 | 0.45 |
| HLMI | dg/min | 39.37 | 37.55 | 39.18 |
| Shear Res. | HLMI/MI | 86 | 82 | 87 |

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1-34. (canceled)

35. A process to produce a pre-catalyst, the process comprising:
subjecting a mixture of a sublimable titanium compound, a sublimable chromium compound, and an oxide support material to a temperature in a range from 100° C. to 300° C. to form the pre-catalyst.

36. The process of claim 35, wherein the process is conducted in an inert atmosphere.

37. The process of claim 35, wherein the process comprises fluidizing the mixture with nitrogen.

38. The process of claim 35, wherein:
the sublimable titanium compound comprises titanocene dichloride and/or titanium oxyacetylacetonate; and
the sublimable chromium compound comprises chromium (III) acetylacetonate.

39. The process of claim 35, wherein the oxide support material is silica.

40. The process of claim 35, wherein the temperature is in a range from 120° C. to 250° C.

41. The process of claim 35, wherein the pre-catalyst comprises:
greater than 80 wt. % oxide support material;
between 0.1 wt. % and 3 wt. % chromium; and
between 0.5 wt. % and 6 wt. % titanium.

42. The process of claim 41, wherein the pre-catalyst comprises titanocene dichloride.

43. The process of claim 41, wherein the pre-catalyst comprises titanium oxyacetylacetonate.

44. A process to produce a catalyst, the process comprising:
subjecting the pre-catalyst of claim 41 to an oxidizing atmosphere at an activation temperature in a range from 500° C. to 900° C. to produce the catalyst.

45. A process to produce a pre-catalyst, the process comprising:
subjecting a mixture of a sublimable titanium compound and a chromium/oxide support material to a temperature in a range from 100° C. to 300° C. to form the pre-catalyst.

46. The process of claim 45, wherein the process is conducted in an inert atmosphere.

47. The process of claim 45, wherein the process comprises fluidizing the mixture with nitrogen.

48. The process of claim 45, wherein:
the sublimable titanium compound comprises titanocene dichloride and/or titanium oxyacetylacetonate; and
the chromium/oxide support material is a chromium/silica.

49. The process of claim 45, wherein the pre-catalyst comprises:
greater than 80 wt. % oxide support material;
between 0.1 wt. % and 3 wt. % chromium;
between 0.5 wt. % and 6 wt. % titanium; and
titanocene dichloride and/or titanium oxyacetylacetonate.

50. A process to produce a catalyst, the process comprising:
subjecting the pre-catalyst of claim 49 to an oxidizing atmosphere at an activation temperature in a range from 500° C. to 900° C. to produce the catalyst.

51. A process to produce a pre-catalyst, the process comprising:
(a) subjecting a mixture of a sublimable titanium compound and an oxide support material to a temperature in a range from 100° C. to 300° C.; and
(b) impregnating the oxide support material with chromium to form the pre-catalyst.

52. The process of claim 51, wherein step (a) comprises fluidizing the mixture with nitrogen.

53. The process of claim 51, wherein the sublimable titanium compound comprises titanocene dichloride and/or titanium oxyacetylacetonate.

54. The process of claim 51, wherein the pre-catalyst comprises:
greater than 80 wt. % oxide support material;
between 0.1 wt. % and 3 wt. % chromium;
between 0.5 wt. % and 6 wt. % titanium; and
titanocene dichloride and/or titanium oxyacetylacetonate.
